(19) United States
(12) Patent Application Publication
(10) Pub. No.: US 2004/0015707 A1
(43) Pub. Date: Jan. 22, 2004

(54) Control system for protecting external program codes

(76) Inventor: Jong Oh Lee, Kyoungki-do (KR)

Correspondence Address: MARSHALL, GERSTEIN & BORUN LLP, 6300 SEARS TOWER, 233 S. WACKER DRIVE, CHICAGO, IL, 60606, US

(21) Appl. No.: 10/330,862

(22) Filed: Dec. 27, 2002

(30) Foreign Application Priority Data
Jul. 19, 2002 (KR) 2002-42534

(51) Int. Cl. G06F 12/14

(52) U.S. Cl. 713/189

(57) ABSTRACT

The present disclosure discloses a control system for protecting external program codes, which can prevent the program codes of an external ROM from being leaked by encrypting address signals and data codes. The control system for protecting the external program codes includes an external ROM configured to store the program codes, and a micro-controller configured to read and to process the program codes from the external ROM. The external ROM stores the encrypted program codes, and the micro-controller decrypts and uses the encrypted program codes from the external ROM. Here, the micro-controller reads the program codes from the external ROM and uses encrypted address signals. The external ROM stores reordered program codes according to the encrypted address signals.

### TECHNICAL FIELD

The present disclosure relates generally to semiconductor memory devices, and more particularly, to a control system for protecting external program codes.

### BACKGROUND

Program codes must be essentially protected in constitution of an application system requiring an external program memory. FIG. 1 is a block diagram illustrating a conventional system for protecting external program codes, which includes an external read only memory (ROM) 200 for storing the encrypted program codes, and a micro-controller 100 for reading the encrypted program codes stored in the external ROM 200 and controlling the system by using the encrypted program codes. In particular, the micro-controller 100 includes a cipher analysis unit 110 that has encryption information for analyzing and transforming the encrypted program codes from the external ROM 200 into usable original program codes, an external ROM interface 120 for transmitting the program codes from the cipher analysis unit 110 to an internal code bus 125, an instruction register 130 for storing the program codes from the internal code bus 125, and a program counter 140 that has location information of the program codes to read them from the external ROM 200 for outputting address signals Add[15:0].

For example, when a data rate between the external ROM 200 and the micro-controller 100 is 8 bits and an encryption key is 2-0-5-3-7-6-1-4, the program codes stored in the external ROM 200 in 8 bit units are reordered in the order of D2, D0, D5, D3, D7, D6, D1 and D4, encrypted, and stored. When the program codes stored in the address from the program counter 140 are transmitted from the external ROM 200 to the micro-controller 100, the program codes are transmitted in the order of D2, D0, D5, D3, D7, D6, D1 and D4. Accordingly, the program codes cannot be decrypted without the encryption key. As a result, the contents of the program codes cannot be recovered.

When the encrypted program codes are transmitted, the cipher analysis unit 110 outputs the data from the external ROM 200 (i.e., data from input ports PI7 to PI0) through its output ports PO7 to PO0 by using a bit-reorder logic for reordering the encrypted and reordered program codes into the original program codes. In particular, the cipher analysis unit 110 outputs the data D2 from port PI7 through port PO2, the data D0 from port PI6 through port PO0, the data D5 from port PI5 through port PO5, the data D3 from port PI4 through port PO3, the data D7 from port PI3 through port PO7, the data D6 from port PI2 through port PO6, the data D1 from port PI1 through port PO1, and the data D4 from port PI0 through port PO4. That is, the cipher analysis unit 110 receives the program codes stored in the external ROM 200 in the encryption key order (D2, D0, D5, D3, D7, D6, D1, D4), reorders the program codes into the original codes (D7, D6, D5, D4, D3, D2, D1, D0), and outputs the reordered program codes.

The program codes outputted from the cipher analysis unit 110 are stored in the instruction register 130 through the external ROM interface 120 and the internal code bus 125, and the instruction register 130 patches the program codes to execute the program. However, the source program of the external ROM may be leaked simply by the built-in encryption key.

In general, after a micro-controller is reset, a program counter has a value of ‘0000h’. A jump instruction to jump a program code location exists in ‘0000h’ address of a ROM in order for the ROM to provide the program codes according to an external instruction. For example, Intel 8051 group instruction is ‘LJMP 1000h’, which jumps to 1000h address to actually execute the program. When LJMP 1000h is transformed into hexadecimal codes to be written on the ROM, LJMP is transformed into 02h, 10 of 1000h is transformed into 10h, and 00 of 1000h is transformed into 00h. Therefore, 02h is written on 0000h address of the ROM, 10h is written on 0001h address of the ROM, and 00h is written on 0002h address of the ROM. By knowing the value of 0000h address is 02h, the encryption key may possibly be detected. As a result, the program codes can be analyzed with one encryption key, and the program may be easily leaked.

### SUMMARY OF THE DISCLOSURE

A control system for protecting external program codes configured to prevent data of an external ROM from being leaked by using address encryption keys and multiple encryption keys is disclosed herein. The control system for protecting external program codes includes: an external ROM configured to store program codes associated with a program; and a micro-controller configured to read and to process the program codes from the external ROM. The micro-controller includes a program counter having information of location where the program codes are stored to output address signals; an address encryption unit configured to encrypt the address signals, and to output the encrypted addresses to the external ROM; a multiple cipher analysis unit configured to receive encryption information from the address encryption unit in response to the program codes from the external ROM, to decrypt multiple ciphers of the program codes with the encryption information, and to transform the program codes into original program codes; and an instruction register configured to store the original program codes transmitted from the multiple cipher analysis unit through an internal interface and a bus, and to patch the original program codes to execute the program. The external ROM stores the program codes encrypted by the multiple ciphers in the encrypted address location, and transmits the multiple encrypted program codes corresponding to the encrypted addresses of the address encryption unit to the multiple cipher analysis unit.

### BRIEF DESCRIPTION OF THE DRAWINGS

The disclosure will be described in terms of several embodiments to illustrate its broad teachings. Reference is also made to the attached drawings.

FIG. 1 is a block diagram illustrating a conventional system for protecting external program codes;

FIG. 2 is a block diagram illustrating a system for protecting program codes of an external ROM by using multiple encryption keys;

FIG. 3 is a block diagram illustrating a system for protecting program codes of an external ROM by using address encryption keys; and

FIG. 4 is a block diagram illustrating a system for protecting external program codes by using multiple encryption keys and address encryption keys.

### DETAILED DESCRIPTION

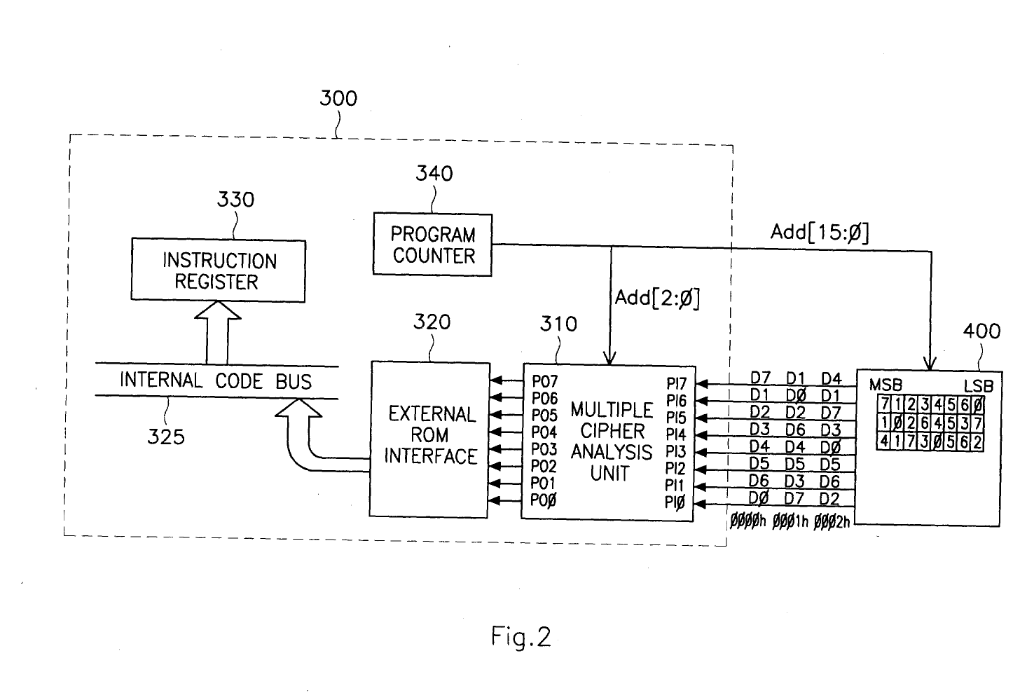

A system for protecting external codes will be described in detail with reference to the accompanying drawings. In particular, FIG. 2 is a block diiagram illustrating a system for protecting program codes of an external ROM by using multiple encryption keys. Referring to FIG. 2, the system for protecting the program codes of the external ROM by using the multiple encryption keys includes an external ROM 400 configured to store the multiple encrypted program codes, and a micro-controller 300 configured to read the multiple encrypted program codes from the external ROM 400 and to control the system with the multiple encrypted program codes.

The micro-controller 300 includes a multiple cipher analysis unit 310 configured to analyze and to transform the multiple encrypted program codes from the external ROM 400 into usable original program codes by using multiple encryption information, an external ROM interface 320 configured to transmit the program codes from the multiple cipher analysis unit 310 to an internal code bus 325, an instruction register 330 configured to store the program codes from the internal code bus 325, and a program counter 340 having address information of the external ROM 400 where the program codes are stored for outputting address signals Add[15:0].

The system protects the program codes of the external ROM 400 by using the multiple encryption keys. Here, eight encryption keys are exemplified. For example, eight (8=2³) encryption keys are generated by using lower 3 bits Add[2:0] of the addresses Add[15:0] from the program counter 340. That is, the same encryption keys are used when the addresses are repeated in every lower 3 bits of predetermined bits.

Table 1 shows an encryption table using optional encryption keys. That is, any values are usable.

TABLE 1

| Add [2:0] | Encryption Keys |
|---|---|
| 000 | 7-1-2-3-4-5-6-0 |
| 001 | 1-0-2-6-4-5-3-7 |
| 010 | 4-1-7-3-0-5-6-2 |
| 011 | 0-5-2-7-4-1-6-3 |
| 100 | 6-3-2-1-7-5-0-4 |
| 101 | 5-2-1-7-4-0-6-3 |
| 110 | 2-1-6-3-5-4-0-7 |
| 111 | 1-0-2-4-3-5-7-6 |

The program codes reordered by the encryption keys of Table 1 are stored in the external ROM 400. When the lower 3 bits Add[2:0] of the addresses of the storing location of the external ROM 400 are same as Table 1, the program codes to be stored in the external ROM are reordered according to the corresponding encryption keys. For example, in accordance with the encryption keys of Table 1, the program codes are stored in 0000h address of the external ROM 400 in the order of D7, D1, D2, D3, D4, D5, D6 and D0, in 0001h address of the external ROM 400 in the order of D1, D0, D2, D6, D4, D5, D3 and D7, and in 0002h address of the external ROM 400 in the order of D4, D1, D7, D3, D0, D5, D6 and D2.

Thereafter, the multiple cipher analysis unit 310, which receives the encrypted program codes from the external ROM 400 through input ports PI7 to PI0, analyzes the program codes by referring to the addresses Add[2:0] used for the encryption from the program counter 340. The multiple cipher analysis unit 310 also transforms the program codes into the original program codes, and outputs the original program codes through output ports PO7 to PO0. In more detail, in the data inputted from the 0000h address to the multiple cipher analysis unit 310 in the order of D7, D1, D2, D3, D4, D5, D6 and D0, the multiple cipher analysis unit 310 outputs the data D7 from port PI7 through port PO7, the data D1 from port PI6 through port PO1, the data D2 from port PI5 through port PO2, the data D3 from port PI4 through port PO3, the data D4 from port PI3 through port PO4, the data D5 from port PI2 through port PO5, the data D6 from port PI1 through port PO6, and the data D0 from port PI0 through port PO0.

In the data inputted from the 0001h address to the multiple cipher analysis unit 310 in the order of D1, D0, D2, D6, D4, D5, D3 and D7, the multiple cipher analysis unit 310 outputs the data D1 from port PI7 through port PO1, the data D0 from port PI6 through port PO0, the data D2 from port PI5 through port PO2, the data D6 from port PI4 through port PO6, the data D4 from port PI3 through port PO4, the data D5 from port PI2 through port PO5, the data D3 from port PI1 through port PO3, and the data D7 from port PI0 through port PO7. That is, when the program codes are transmitted according to the address signals of the program counter 340, the multiple cipher analysis unit 310 analyzes the program codes by using the address information, reorders the program codes into the original program codes, and transmits them to the external ROM interface 320.

The program codes outputted from the multiple cipher analysis unit 310 are stored in the instruction register 330 through the external ROM interface 320 and the internal code bus 325, and the instruction register 330 patches the program codes to execute the program. The addresses are repeated in every lower 3 bits. Thus, the micro-controller 300 interprets the program codes by using the corresponding encryption key.

Here, the lower 3 bits of the addresses were exemplified as the encryption keys, but any bits of the addresses can be used. Because the bit order of the program codes can be varied maximally for the entire addresses, a size of the program can be a maximum number of the encryption keys. As described above, in the system for protecting the program codes of the external ROM by using the multiple encryption keys, the program source codes may not be detected without knowing all of the encryption keys.

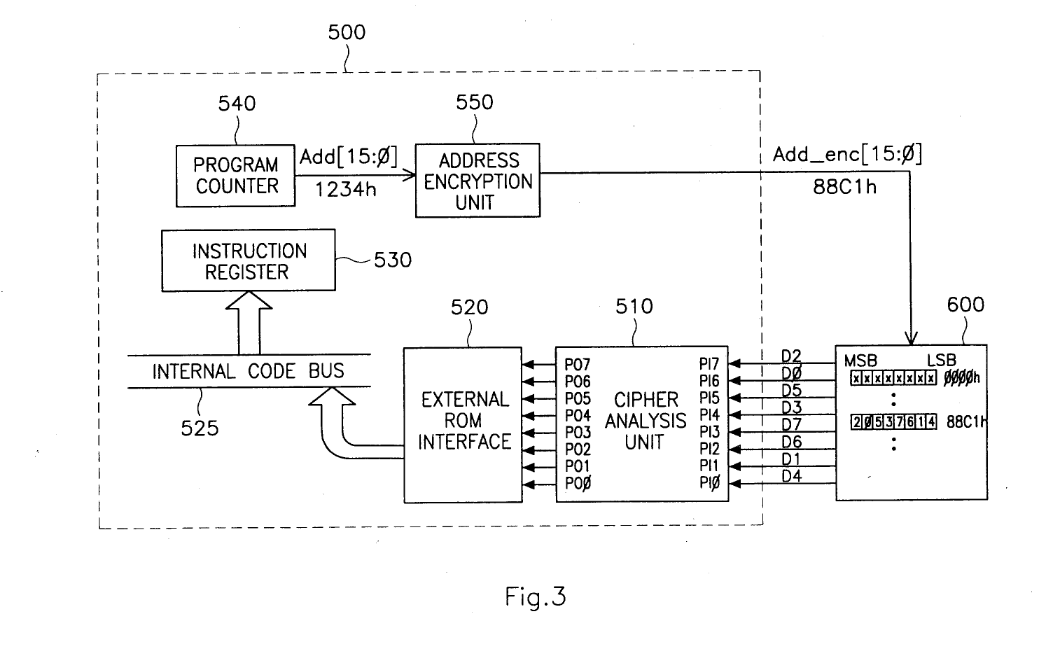

FIG. 3 is a block diagram illustrating a system for protecting program codes of an external ROM by using address encryption keys. Here, addresses of the program codes are not transmitted without alteration. That is, using addresses as the encryption keys changes bit orders of the addresses.

As illustrated in FIG. 3, the system for protecting the program codes of the external ROM by using the address encryption keys includes an external ROM 600 configured to store the encrypted program codes, and a micro-controller 500 configured to read the encrypted program codes from the external ROM 600 and to control the whole system with the encrypted program codes.

The micro-controller 500 includes a cipher analysis unit 510, an external ROM interface 520, an instruction register 530, a program counter 540 and an address encryption unit 550. The cipher analysis unit 510 has encryption information for analyzing and transforming the encrypted program codes from the external ROM 600 into usable original program codes, and the external ROM interface 520 transmits the program codes from the cipher analysis unit 510 to an internal code bus 525. The instruction register 530 stores the program codes from the internal code bus 525. The program counter 540 has address information of the external ROM 600 where the program codes are stored to output address signals Add[15:0]. The address encryption unit 550 encrypts the address signals Add[15:0], and outputs the encrypted address signals Add_enc[15:0].

When the program counter 540 transmits the address signal of 1234h address and if the encryption key is 12-13-14-15-9-8-11-10-5-4-7-6-1-0-3-2, the address encryption unit 550 transforms 1234h into 88C1h and outputs the resulting address. When the encrypted address is transmitted to the external ROM 600, the external ROM 600 transmits the program codes of 88C1h address to the micro-controller 500. Here, the program codes are stored on the external ROM 600 according to the encrypted address reordered by the encryption key of the address encryption unit 550.

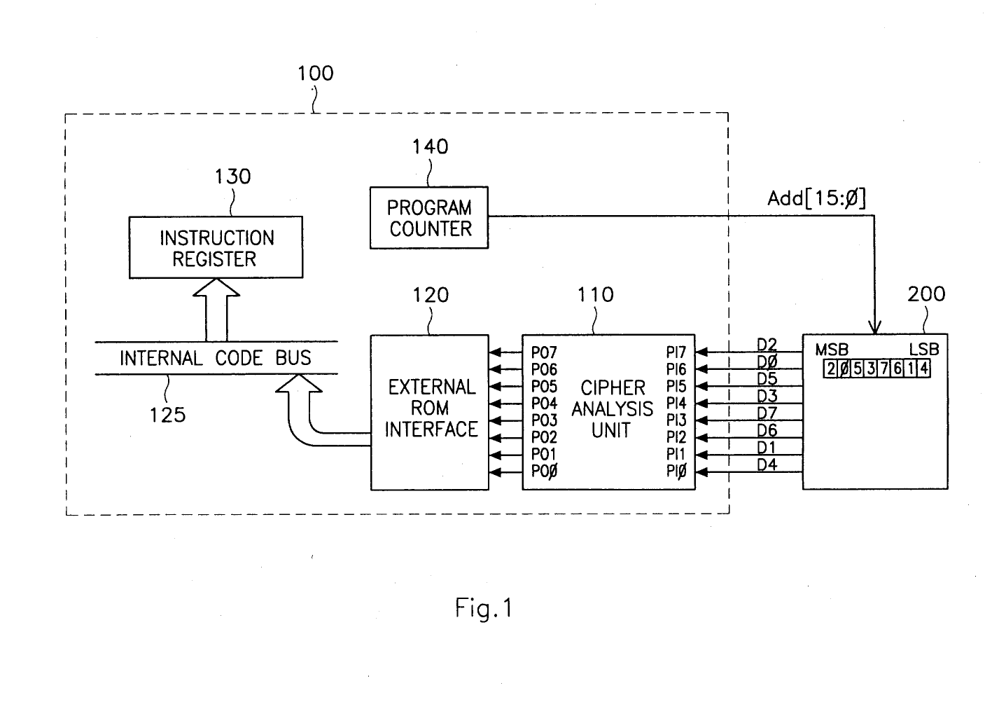

In addition, because the program codes transmitted to the micro-controller 500 have already been arranged according to one encryption key, the cipher analysis unit 510 re-arranges the program codes with the encryption key as described with reference to FIG. 1 and outputs the original program codes to execute the program. Therefore, even if one encryption key of the program code is detected, the analyzed program source codes may be useless without knowing a flow (order) of the program by the addresses.

The present disclosure is not limited to the system using the multiple encryption keys or the address encryption keys. The present disclosure may also simultaneously embody the system for protecting the program codes of the external ROM by using the multiple encryption keys as shown in FIG. 2 and the system for protecting the program codes of the external ROM by using the address encryption keys as shown in FIG. 3 into a single system. As a result, the protection of the program codes and flow can be doubled by changing the bit order of the program codes to be stored on the external ROM by using the multiple encryption keys, and changing the storing location of the program codes by using the address encryption keys.

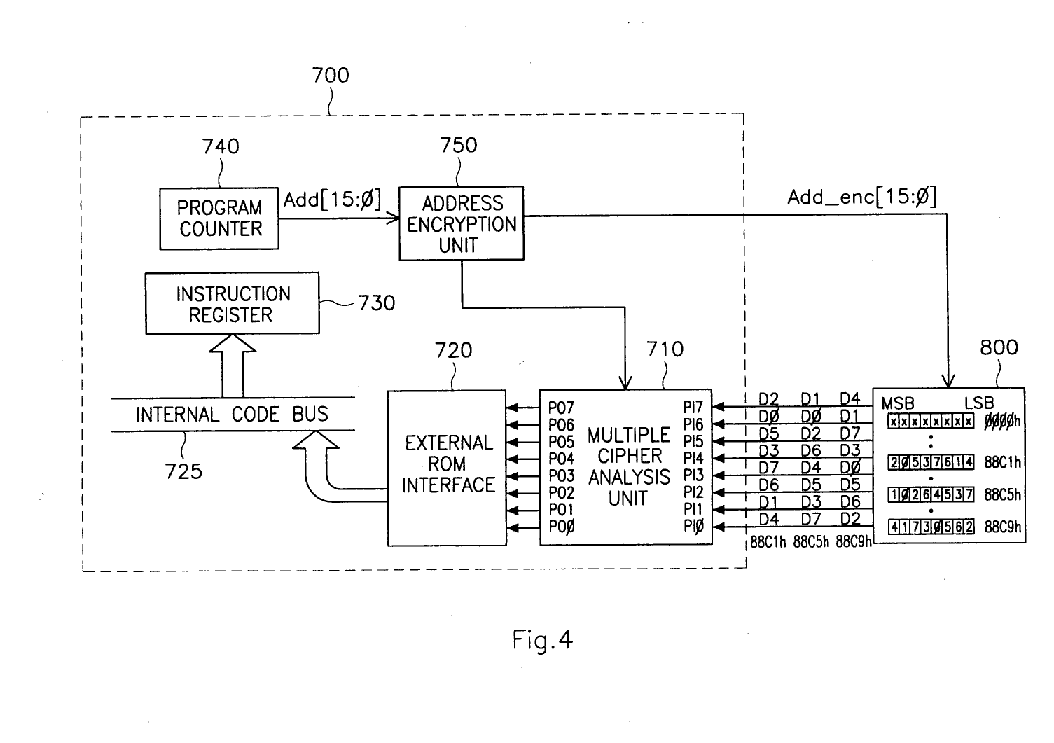

FIG. 4 is a block diagram illustrating a system for protecting external program codes by using multiple encryption keys and address encryption keys. The system for protecting the program codes of the external ROM by simultaneously using the multiple encryption keys and the address encryption keys includes an external ROM 800 configured to store the multiple encrypted program codes, and a micro-controller 700 configured to read the multiple encrypted program codes stored in the external ROM 800 and to control the system by using the multiple encrypted program codes.

The micro-controller 700 includes a multiple cipher analysis unit 710 that has multiple encryption information for analyzing and transforming the multiple encrypted program codes from the external ROM 800 into usable original program codes, an external ROM interface 720 configured to transmit the program codes from the multiple cipher analysis unit 710 to an internal code bus 725, an instruction register 730 configured to store the program codes from the internal code bus 725, and a program counter 740 having address information of the external ROM 800 where the program codes are stored to output address signals Add[15:0]. In addition, the micro-controller 700 further includes an address encryption unit 750 configured to encrypt the address signals Add[15:0] from the program counter 740, and to output the encrypted address signals Add_enc[15:0].

When the program counter 740 transmits the address signals of 1234h to 1236h addresses and if the encryption key is 12-13-14-15-9-8-11-10-5-4-7-6-1-0-3-2, the address encryption unit 750 transforms 1234h into 88C1h, 1235h into 88C5h, and 1236h into 88C9h, and outputs the resulting addresses. When the encrypted addresses are transmitted to the external ROM 800, the external ROM 800 transmits the program codes of 88C1h, 88C5h and 88C9h addresses to the micro-controller 700.

Here, the program codes are stored on the external ROM 800 according to the encrypted addresses and reordered according to the encryption key of the address encryption unit 750. Although the encrypted address is transmitted, the program codes supposed to exist in the original address are transmitted to the micro-controller 700. That is, the program codes of 88C1h, 88C5h and 88C9h addresses are identical to the program codes of 1234h to 1236h addresses, which the micro-controller 700 intended to use. Thus, the micro-controller 700 uses the program codes of 88C1h, 88C5h and 88C9h addresses without any changes.

However, because the program codes of 88C1h, 88C5h and 88C9h addresses have already been reordered according to the multiple encryption keys, the multiple cipher analysis unit 710 reorders the program codes into the original program codes by referring to the address encryption unit 750, and outputs the original program codes for the micro-controller 700 to execute the program. Also, because the multiple encryption keys and the address encryption keys are used at the same time, the program may not be used without knowing the program codes and flow. As discussed earlier, using the multiple encryption keys and the address encryption keys can protect the program codes stored in the external ROM.

Many changes and modifications to the embodiments described herein could be made. The scope of some changes is discussed above. The scope of others will become apparent from the appended claims.

What is claimed is:

1. A control system for protecting external program codes, the system comprising:
an external ROM configured to store program codes associated with a program; and
a micro-controller configured to read and to process the program codes from the external ROM, wherein the micro-controller comprises:
a program counter having location information of location where the program codes are stored, the program counter configured to output address signals;
an address encryption unit configured to encrypt the address signal, and to output encrypted addresses to the external ROM;
a multiple cipher analysis unit configured to receive an encryption information from the address encryption unit in response to the program codes from the external ROM, to decrypt multiple ciphers of the program codes with the encryption information, and to transform the program codes into original program codes; and
an instruction register configured to store the original program codes transmitted from the multiple cipher analysis unit through an internal interface and a bus, and to patch the original program codes to execute the program,
wherein the external ROM stores the program codes encrypted by the multiple ciphers in an encrypted address location, and transmits the multiple encrypted program codes corresponding to the encrypted addresses of the address encryption unit to the multiple cipher analysis unit.

2. The control system according to claim 1, wherein the multiple encrypted external program codes are stored by using different bit orders in the respective addresses corresponding to encrypted address information of the address encryption unit.

3. The control system according to claim 1, wherein the multiple encrypted external program codes are stored by using the same bit order in predetermined intervals of the addresses corresponding to encrypted address information of the address encryption unit.

4. A control system for protecting external program codes, the system comprising:
an external ROM configured to store program codes associated with a program; and
a micro-controller configured to read and to process the program codes from the external ROM, wherein the micro-controller comprises:
a program counter having information of location where the program codes are stored to output address signals;
a multiple cipher analysis unit configured to receive address information from the program counter in response to the program codes from the external ROM, to decrypt multiple ciphers of the program codes with the address information, and to transform the program codes into original program codes; and
an instruction register configured to store the original program codes transmitted from the multiple cipher analysis unit through an internal interface and a bus, and to patch the original program codes to execute the program, and
wherein the external ROM stores the program codes encrypted by the multiple ciphers in an address location, and transmits the multiple encrypted program codes corresponding to addresses of the program counter to the multiple cipher analysis unit.

5. The control system according to claim 4, wherein the multiple encrypted external program codes are stored by using different bit orders in the respective addresses corresponding to address information of the program counter.

6. The control system according to claim 4, wherein the multiple encrypted external program codes are stored by using the same bit order in predetermined intervals of the addresses corresponding to address information of the program counter.

7. A control system for protecting external program codes, the system comprising:
an external ROM configured to store program codes associated with a program; and
a micro-controller configured to read and to process the program codes from the external ROM, wherein the micro-controller comprises:
a program counter having information of location where the program codes are stored, the program counter configured to output address signals;
an address encryption unit configured to encrypt the address signals, and to output the encrypted addresses to the external ROM;
a cipher analysis unit configured to decrypt ciphers of the program codes, and to transform the program codes into original program codes in response to the program codes from the external ROM; and
an instruction register configured to store the original program codes transmitted from the cipher analysis unit through an internal interface and a bus, and to patch the original program codes to execute the program, and
wherein the external ROM stores the program codes encrypted by the ciphers in an encrypted address location, and transmits the encrypted program codes corresponding to encrypted addresses of the address encryption unit to the cipher analysis unit.

8. The control system according to claim 7, wherein the encrypted external program codes are stored by using the same bit orders in the entire addresses.
